(19) United States
(12) Patent Application Publication
(10) Pub. No.: US 2009/0053410 A1
(43) Pub. Date: Feb. 26, 2009

(54) COMPACT PAINTING PROCESS

(75) Inventors: Timothy Salatin, Brighton, MI (US); Gregory G. Menovcik, Northville, MI (US); Timothy S. December, Rochester Hills, MI (US)

Correspondence Address: HOWARD & HOWARD ATTORNEYS, P.C.;BASF CORPORATION, THE PINEHURST OFFICE CENTER, SUITE #101, 39400 WOODWARD AVENUE, BLOOMFIELD HILLS, MI, 48304-5151, US

(73) Assignee: BASF CORPORATION, SOUTHFIELD, MI (US)

(21) Appl. No.: 11/843,080

(22) Filed: Aug. 22, 2007

(51) Int. Cl. B05D 3/02

(52) U.S. Cl. 427/202; 427/379

(57) ABSTRACT

A method of painting a substrate coated with an electrocoat, wherein the electrocoat includes an average surface roughness equal to or greater than 3 microns, includes applying a two-component sealer onto the electrocoat to form a film having a thickness of from 5 microns to 20 microns. The two-component sealer is partially cured by application of heat to a gel content of from 10 to 50 wt. %. Thereafter, a topcoat, typically including a basecoat and a clearcoat, is applied onto the two-component sealer. Both the two-component sealer and the topcoat are completely cured by application of heat.

### BACKGROUND OF THE INVENTION

1. Field of the Invention

The subject invention generally relates to a method of painting a substrate, and more specifically to a method of painting a substrate coated with an electrocoat having an average surface roughness (Rₐ) equal to or greater than 0.3 microns with a two-component sealer.

2. Description of the Related Art

A typical industrial painting process for painting a substrate includes preparing the substrate. The substrate may include a vehicle, a vehicle panel, or some other object. Preparation of the substrate may include cleaning the substrate with an iron phosphate wash, and then applying an electrocoat to the substrate by electrodeposition. The electrocoat is cured in an oven and is then typically sanded to provide a smooth surface. A primer is then applied over the electrocoat. Once the primer has formed a film, i.e., flashed over, the primer is cured in an oven and then sanded to provide a smooth surface. A topcoat is then applied over the primer. The topcoat typically includes a basecoat (i.e., a color coat) and a clearcoat. The basecoat is preferably applied in two coats, with the clearcoat being applied on the basecoat after the basecoat has formed a film, i.e., flashed over. After the clearcoat bas been applied, the substrate is placed in an oven to cure both the basecoat and the clearcoat.

The electrocoat, once applied to the substrate, includes an average surface roughness (Ra), which is a measurement of the irregularities in the surface of the electrocoat. The average surface roughness is the arithmetic average of the absolute deviations from a mean surface level of the substrate. An average surface roughness of equal to or less than 0.1 microns in the electrocoat translates into a high quality appearance of the topcoat. The quality appearance of the topcoat may be measured by indices such as the gloss of the topcoat or the distinctiveness of image (DOI) of the topcoat. An average surface roughness equal to or greater than 0.3 microns in the electrocoat translates into a poor quality appearance of the topcoat. Accordingly, a surface having an average surface roughness equal to or greater than 0.3 microns must be bridged, i.e., filled in, in order to provide a high quality appearance to the topcoat.

The primer bridges the surface irregularities of the electrocoat to provide a high quality appearance. The primer is generally applied in a film having a thickness of from 25 microns to 60 microns, depending upon the type of primer utilized. For example, a solvent based primer typically includes a film thickness of from 25 microns to 30 microns, a water based primer typically includes a film thickness of from 30 microns to 35 microns, and a powder primer typically includes a film thickness of from 50 microns to 60 microns. The primer, having a film thickness as described above, also provides ultra-violet light protection against transmission of light through the primer. The primer typically blocks ultra-violet light having a wavelength of from 250 nm to 400 nm.

The use of the primer, however, necessitates the curing of the primer in an oven. The curing of the primer in the oven consumes significant space along a production line. Additionally, the curing process requires a large amount of energy to heat the oven, thereby adding to the cost of painting the substrate. Additionally, the high film thickness required by the primer increase the material usage, thereby driving up the production costs. Therefore, it would be desirable to eliminate the primer and the oven necessary to cure the primer from the painting process, while still providing a high quality appearance of the painted substrate and the ultra-violet light protection.

### SUMMARY OF THE INVENTION AND ADVANTAGES

The subject invention provides a method of painting a substrate coated with an electrocoat with a two-component sealer and a topcoat. The substrate coated with the electrocoat has an average surface roughness (Rₐ) equal to or greater than 0.3 microns. The method of the subject invention more specifically comprises the steps of applying the two-component sealer to the electrocoat to form a film having a thickness of from 5 microns to 20 microns, partially curing the two-component sealer, applying the topcoat onto the two component sealer, and then completely curing the two-component sealer and the topcoat by application of heat.

Accordingly, the subject invention provides a method of painting a substrate suitable for industrial applications. The method of the subject invention replaces a conventional primer with a two-component sealer. The two-component sealer includes a film thickness considerably less than a conventional primer, thereby reducing the overall film thickness of the painted substrate while still providing the bridging necessary to reduce the average surface roughness to a level equal to or less than 0.1 micron to obtain a high quality appearance. The two-component sealer also provides the same ultra-violet light protection. Furthermore, with the two-component sealer of the subject invention, there is no sanding required as with a conventional primers, where sanding is typically required after a full cure. Thus, various process costs, such as the costs associated with time and material, are reduced.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a flowchart generally illustrating the painting method of the present invention.

### DETAILED DESCRIPTION OF THE INVENTION

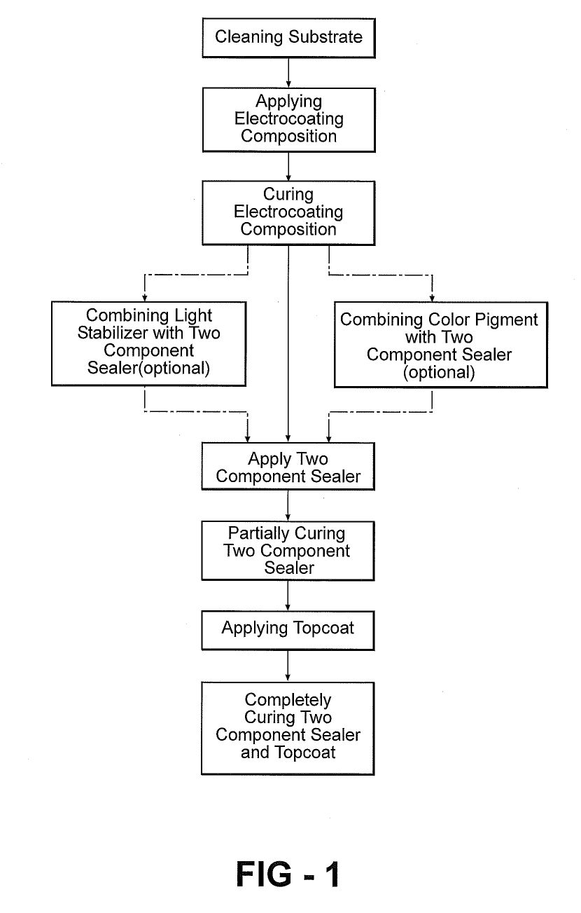

Referring to FIG. 1, a method of painting a substrate is generally shown. The method includes application of a two-component sealer onto the substrate, and application of a topcoat onto the two-component sealer. The topcoat typically includes a basecoat and a clearcoat, but may also only include the clearcoat, i.e., no basecoat is utilized and the clearcoat is applied onto the two-component sealer. It should also be understood that the topcoat may only include the basecoat, i.e., no clearcoat is utilized and the basecoat is applied onto the two-component sealer.

The substrate is usually prepared prior to application of the two-component sealer onto the substrate. Preparation of the substrate typically includes cleaning the substrate with an iron phosphate wash. After cleaning the substrate, an electrocoat is applied to the substrate. The electrocoat is preferably applied by a process known as electrodeposition, in which the substrate is electrically charged and immersed in a bath of the electrocoat. The bath of the electrocoat includes an opposite electrical charge relative to the substrate. The particles of the electrocoat in the bath are attracted to the substrate, neutralized, and then cured. The preferred method includes making the substrate the cathode, in which the process is called cathodic electrocoating as is well known in the art. The electrocoat, which is deposited on to the substrate, is cured in an oven prior to application of the two-component sealer. Curing the electrocoat typically involves placing the substrate in an oven at a temperature of from 160° C. to 180° C. for 15 to 25 minutes. It should be understood that other methods of curing the electrocoat may also be utilized. After the electrocoat is cured, final preparation of the substrate includes sanding the electrocoat to reduce the average roughness (Rₐ) of the electrocoat. It should be understood that the average roughness (Rₐ) of the electrocoat represents the surface roughness of the electrocoat on the substrate, and is not a measurement of the surface roughness of the substrate itself.

The painting method of this invention utilizes the two-component sealer to bridge, i.e., fill, the surface irregularities of the electrocoat, which includes an average surface roughness equal to or greater than 0.3 microns, to provide for a high quality appearance of the topcoat. The two-component sealer is typically a liquid and is typically a solvent based, i.e., solventborne, two-component sealer. The two-component sealer includes a first component and a second component with the first and second components being reactive with one another. More specifically, the first and second components cross-link with one another to form a cross-linked network. The first component may include an isocyanate-functional resin, a carboxy-functional resin, or combinations thereof. One example of an exemplary first component is a carboxy-functional acrylic resin. The second component may include a hydroxy-functional resin, an epoxy-functional resin, or combinations thereof. If the first component of the two-component sealer is the isocyanate-functional resin, then the second component is preferably the hydroxyl-functional resin. If the first component of the two-component sealer is the carboxy-functional resin, then the second component is preferably the epoxy-functional resin. It should be appreciated that the first component and the second component may include other resins and/or compositions not specifically enumerated herein. Of course, it is also to be appreciated that each of the first and second components can include other chemical components, such as a color pigment or a UV (ultra violet) additive, as indicated below. Examples of suitable two-component sealers are disclosed in U.S. Pat. No. 6,162,891, the disclosure of which is herein incorporated by reference.

It should be understood that the subject invention is not limited to the specific two-component sealers disclosed in U.S. Pat. No. 6,162,891, and that the subject invention may be practiced with other suitable two-component sealers. As is understood by those skilled in the art, the two-component sealer of the present invention is “two-component” in the general sense that, to control reactivity, the first and second components are retained separate from one another and are independently supplied to an application device, such as a spray gun or rotary bell, where the first and second components are then mixed at ‘the tip’ of the application device, typically in a mixing chamber of the application device.

As mentioned above, the average surface roughness of the electrocoat refers to the electrocoat on the substrate, and not the substrate itself. It should be understood that the painting method disclosed herein may also be practiced with a substrate having an average surface roughness of less than 0.3 microns. The painting method comprises applying the two-component sealer to the electrocoat to form a film having a thickness of from 5 microns to 20 microns. More preferably, the two-component sealer forms a film having a thickness of from 10 microns to 20 microns, and even more preferably, the two-component sealer forms a film having a thickness of from 10 microns to 15 microns. As described above, the two-component sealer comprises a liquid, and the step of applying the two-component sealer is further defined as applying the two-component sealer using standard liquid two-component spray painting techniques as are well known in the art.

The two-component sealer also provides the necessary ultra-violet light protection to the substrate. More specifically, the two-component sealer used in the method of this invention provides the necessary ultra-violet protection to the substrate at the film thickness of from 5 microns to 20 microns. Accordingly, the two-component sealer prevents transmission of light through the two-component sealer. Preferably, the two-component sealer blocks ultra-violet light having a wavelength of from 250 nm to 400 nm, more typically of from 380 nm to 400 nm, with the film thickness of the two-component sealer being of from 5 microns to 20 microns. In the context of the present invention, the terms ‘preventing transmission’ or ‘blocking’ ultra-violet light mean that a 5 to 20 micron free film of the two-component sealer permits less than 1%, more preferably less than 0.1%, of ultra-violet light from transmitting through the free film. To produce the free film of the two-component sealer, the two-component sealer is applied in a film build wedge on a release film of Tedlar® and then cured. The film build wedge varies from, at least, 5 to 20 microns. The film is then removed from the release film and ultraviolet light is transmitted through the free film where the amount of light that transmits through the free film is evaluated with a conventional ultra-violet spectrophotometer.

The painting method further comprises the step of partially curing the two-component sealer. The two-component sealer is partially cured in an oven by application of heat to include an average surface roughness equal to or below 0.1 microns. The average surface roughness of the two-component sealer of equal to or below 0.1 microns provides a suitable surface for application of the topcoat to produce a high quality appearance (e.g. acceptable gloss and distinctness of image (DOI)).

The step of partially curing the two-component sealer is further defined as partially curing the two component sealer to a gel content of from 10 to 50 wt. %, more typically of from 15 to 35 wt. %, where the gel content is measured in accordance with the principles outlined in ASTM D 2765-01 (2006). The gel content, which is also commonly referred to as gel fraction, directly indicates the extent of cure of the two-component sealer resulting from the reaction, i.e., cross-linking, of the first component and the second component of the two-component sealer. Of course, as is appreciated by those skilled in the art ASTM D 2765-01 (2006), this ASTM method is written in the context of application to crosslinked ethylene plastics; however, for the purposes of the present invention, the same test methods can be applied to the cross-linked reaction product of the first and second components of the two-component sealer.

Preferably, the two-component sealer is partially cured at a temperature of from 40° C. to 100° C. More preferably, the two-component sealer is partially cured at a temperature of from 42° C. to 90° C. Even more preferably, the two-component sealer is partially cured at a temperature of from 60° C. to 80° C. The two-component sealer is preferably partially cured for a time of from 1 minute to 10 minutes. More preferably, the two-component sealer is partially cured for a time of from 1 minute to 6 minutes. Even more preferably, the two-component sealer is partially cured for a time of from 1 minute to 3 minutes.

Optionally, the two-component sealer includes the color pigment, and the painting method further comprises the step of combining the color pigment with the two-component sealer prior to application of the two-component sealer onto the substrate. When the color pigment is utilized and color keyed to match a similarly colored basecoat, a thinner film build (e.g. from 15 microns to 25 microns) of the basecoat may be used, thereby reducing the amount of basecoat used and the cost of painting the substrate. Alternatively, use of a color pigment in the two-component sealer may negate the use of the basecoat, in which case the topcoat only includes the clearcoat with the clearcoat being applied over the partially cured two-component sealer. Use of the color pigment in the two-component sealer without a basecoat may be especially desirable for interior uses, such as within the interior of a vehicle.

In another embodiment, no color pigment is combined with the two-component sealer, and the two-component sealer includes the UV additive, and the painting process may further comprise the step of combining the UV additive with the two-component sealer prior to application of the two-component sealer on to the substrate. The UV additive may include one of a UV light absorber, a hindered amine light stabilizer, or some other suitable product capable of preventing transmission of ultra violet light through the two-component sealer.

The painting process further comprises applying the topcoat onto the two-component sealer, after the two-component sealer has been partially cured. The step of applying the topcoat is further defined as applying the basecoat and thereafter applying the clearcoat wet-on-wet onto the basecoat. The basecoat is typically a water based basecoat, a solvent based basecoat, a powder basecoat, or a slurry basecoat. The step of applying the topcoat is further defined as applying the clearcoat over the basecoat wet-on-wet. Like the basecoat, the clearcoat is typically a water based clearcoat, a solvent based clearcoat, a powder clearcoat, and a slurry based clearcoat. The most preferred embodiment of the subject invention is directed at a solventborne system utilizing a solvent based two-component sealer, a solvent based basecoat, and a solvent based clearcoat.

The basecoat and the clearcoat may be applied by any suitable method known to those skilled in that art that is appropriate to the specific kind of basecoat and clearcoat utilized. Such suitable methods may include powder coating processes or liquid spray painting processes. It should be understood that other methods of applying the basecoat and the clearcoat may also be utilized.

The painting method further comprises completely curing the two-component sealer and the topcoat, including both the basecoat and the clearcoat if both are utilized, by application of heat. To accomplish this, the substrate is preferably placed in an oven and baked at a temperature of from 125° C. to 150° C. for 20 to 40, more typically 30, minutes to completely cure the two-component sealer and the topcoat. If both the basecoat and clearcoat are included in the topcoat, then it is most typical that they are cured simultaneously. However, it should be understood that other methods of completely curing the two-component sealer and the topcoat may also be utilized within the scope of the claims. It should be appreciated that the step of completely curing the two-component sealer and the topcoat is separate from the step of partially curing the two-component sealer. The step of completely curing the two-component sealer and the topcoat is further defined as curing the two-component sealer and the topcoat to include about 100% cross-linking in each of the two-component sealer and the topcoat.

The foregoing invention has been described in accordance with the relevant legal standards, thus, the description is exemplary rather than limiting in nature. Variations and modifications to the disclosed embodiments may become apparent to those skilled in the art and do come within the scope of the invention. Accordingly, the scope of legal protection afforded this invention can only be determined by studying the following claims.

What is claimed is:

1. A method of painting a substrate coated with an electrocoat with a two-component sealer and a topcoat, the electrocoat having an average surface roughness (Ra) equal to or greater than 0.3 microns, said method comprising the steps of:
applying the two-component sealer to the electrocoat to form a film having a thickness of from 5 microns to 20 microns;
partially curing the two-component sealer;
applying the topcoat onto the two-component sealer; and
completely curing the two-component sealer and the topcoat by application of heat.

2. A method as set forth in claim 1 wherein the step of partially curing the two-component sealer is further defined as partially curing the two-component sealer to a gel content of from 10 to 50 wt. %.

3. A method as set forth in claim 2 wherein the step of partially curing the two-component sealer is further defined as partially curing the two-component sealer by application of heat at a temperature of from 40° C. to 100° C.

4. A method as set forth in claim 3 wherein the step of partially curing the two-component sealer is further defined as partially curing the two-component sealer by application of heat at a temperature of from 60° C. to 80° C.

5. A method as set forth in claim 3 wherein the step of partially curing the two-component sealer is further defined as partially curing the two-component sealer by application of heat for a time of from 1 minute to 10 minutes.

6. A method as set forth in claim 5 wherein the step of partially curing the two-component sealer is further defined as partially curing the two-component sealer by application of heat for a time of from 1 minute to 6 minutes.

7. A method as set forth in claim 6 wherein the step of partially curing the two-component sealer is further defined as partially curing the two-component sealer by application of heat for a time of from 1 minute to 3 minutes.

8. A method as set forth in claim 1 wherein the two-component sealer prevents transmission of light, having a wavelength of from 250 nanometers to 400 nanometers, through the two-component sealer with the film thickness of the two-component sealer of from 5 microns to 20 microns.

9. A method as set forth in claim 1 wherein a first component of the two-component sealer comprises an isocyanate-functional resin and a second component of the two-component sealer comprises a hydroxy-functional resin.

10. A method as set forth in claim 1 wherein a first component of the two-component sealer comprises a carboxy-functional resin and a second component of the two-component sealer comprises an epoxy-functional resin.

11. A method as set forth in claim 1 wherein the two-component sealer is a liquid and the step of applying the two-component sealer is further defined as applying the two-component sealer by a spray painting technique.

12. A method as set forth in claim 2 wherein the two-component sealer is partially cured to include an average surface roughness equal to or less than 0.1 microns.

13. A method as set forth in claim 2 wherein the two-component sealer is applied to form a film having a thickness of from 5 microns to 20 microns.

14. A method as set forth in claim 1 wherein the two-component sealer includes a color pigment and the method further comprises the step of combining the color pigment with the two-component sealer prior to application of the two-component sealer.

15. A method as set forth in claim 1 wherein the two-component sealer includes a UV additive and the method further comprises the step of combining the UV additive with the two-component sealer prior to application of the two-component sealer.

16. A method as set forth in claim 15 wherein the UV additive includes a UV light absorber, a hindered amine light stabilizer, or combinations thereof.

17. A method as set forth in claim 1 wherein the step of applying the topcoat is further defined as applying a basecoat.

18. A method as set forth in claim 17 wherein the basecoat is a water based basecoat, a solvent based basecoat, a powder basecoat, or a slurry basecoat.

19. A method as set forth in claim 17 wherein the step of applying the topcoat is further defined as applying a clearcoat over the basecoat.

20. A method as set forth in claim 19 wherein the clearcoat is a water based clearcoat, a solvent based clearcoat, a powder clearcoat, and a slurry based clearcoat.

21. A method as set forth in claim 19 wherein the two-component sealer, the basecoat, and the clearcoat are solvent based.

22. A method as set forth in claim 1 wherein the step of completely curing the two-component sealer and the topcoat by application of heat is further defined as curing the two-component sealer and the topcoat by application of heat at a temperature of from 125° C. to 150° C.
